(19) United States
(12) Patent Application Publication
(10) Pub. No.: US 2021/0383837 A1
(43) Pub. Date: Dec. 9, 2021

(54) METHOD, DEVICE, AND STORAGE MEDIUM FOR PROMPTING IN EDITING VIDEO

(71) Applicant: BEIJING DAJIA INTERNET INFORMATION TECHNOLOGY CO., LTD, Beijing (CN)

(72) Inventors: Jiarui REN, Beijing (CN); Shanshan MAO, Beijing (CN)

(21) Appl. No.: 17/137,767

(22) Filed: Dec. 30, 2020

(30) Foreign Application Priority Data
Jun. 4, 2020 (CN) 202010501355.4

(51) Int. Cl. G11B 27/02; H04N 21/8549; H04N 21/81; G06F 3/0484; G06F 3/0485; G06F 9/54

(52) U.S. Cl. CPC G11B 27/02; H04N 21/8549; H04N 21/8146; G06F 2203/04806; G06F 3/0485; G06F 9/542; G06F 3/04845

(57) ABSTRACT

The disclosure can provide a method, an electronic device, and a storage medium for prompting in editing a video. The method can include the following. A preview of a video is displayed in a preview region of a video editing page. A target material in the preview region is obtained. First boundary information of the target material is obtained in response to the target material being in a selected state. Second boundary information of a safe region in the preview region is obtained. Prompt information corresponding to the safe region is displayed based on the second boundary information, in response to detecting that the target material exceeds the safe region based on the first boundary information and the second boundary information.

### CROSS-REFERENCE TO RELATED APPLICATION

This application is based on and claims priority to Chinese Patent Application No. 202010501355.4 filed on Jun. 4, 2020, the disclosure of which is hereby incorporated herein by reference.

### FIELD

The disclosure relates to the field of image processing technologies, and more particularly, to a method, an electronic device, and a storage medium for prompting in editing a video.

### BACKGROUND

People's requirements about short-form videos are increasing such as needs of adding richer materials into the short-form videos, as the short-form videos become an important means for entertaining and sharing stories for people. In the related art, a user may add materials into videos through an interface of his/her electronic device. However, electronic devices with different sizes of screens may display the same video in different sizes, thereby making the video with which the material has been added by the user cannot be displayed completely on electronic devices of users who watch this video, or not achieving a display purpose of the user who made this video.

### SUMMARY

According to embodiments of the disclosure, a method for prompting in editing a video is provided. The method includes: displaying a preview of a video in a preview region of a video editing page; obtaining a target material in the preview region; obtaining first boundary information of the target material in response to the target material being in a selected state; obtaining second boundary information of a safe region in the preview region; and displaying prompt information corresponding to the safe region based on the second boundary information, in response to detecting that the target material exceeds the safe region based on the first boundary information and the second boundary information.

According to embodiments of the disclosure, an electronic device is provided. The electronic device includes a processor and a storage device configured to store instructions executable by the processor. The processor is configured to execute the instructions to: display a preview of a video in a preview region of a video editing page; obtain a target material in the preview region; obtain first boundary information of the target material in response to the target material being in a selected state; obtain second boundary information of a safe region in the preview region; and display prompt information corresponding to the safe region based on the second boundary information, in response to detecting that the target material exceeds the safe region based on the first boundary information and the second boundary information.

According to embodiments of the disclosure, a computer-readable storage medium is provided. The computer-readable storage medium has stored therein instructions that, when executed by a processor of an electronic device, causes the electronic device to perform a method for prompting in editing a video, the method including: obtaining a target material in the preview region; obtaining first boundary information of the target material in response to the target material being in a selected state; obtaining second boundary information of a safe region in the preview region; and displaying prompt information corresponding to the safe region based on the second boundary information, in response to detecting that the target material exceeds the safe region based on the first boundary information and the second boundary information.

The above general description and the following detailed description are exemplary and explanatory, and cannot limit the disclosure.

### BRIEF DESCRIPTION OF THE DRAWINGS

The drawings herein are incorporated into the specification and form a part of the specification, illustrating embodiments consistent with the disclosure and used together with the specification to explain the principles of the disclosure, and do not constitute undue limitations to the disclosure.

FIG. 1 is a flowchart illustrating a method for prompting in editing a video according to some embodiments of the disclosure.

FIG. 2 is a schematic diagram illustrating a video editing page according to some embodiments of the disclosure.

FIG. 3 is a schematic diagram illustrating a video playing page according to some embodiments of the disclosure.

FIG. 4 is a flowchart illustrating a method for prompting in editing a video according to some embodiments of the disclosure.

FIG. 5 is a schematic diagram illustrating an initial safe region according to some embodiments of the disclosure.

FIG. 6 is a schematic diagram illustrating an initial safe region according to some embodiments of the disclosure.

FIG. 7 is a schematic diagram illustrating an initial safe region according to some embodiments of the disclosure.

FIG. 8 is a schematic diagram illustrating an initial safe region according to some embodiments of the disclosure.

FIG. 9 is a flowchart illustrating a method for prompting in editing a video according to some embodiments of the disclosure.

FIG. 10 is a flowchart illustrating a method for prompting in editing a video according to some embodiments of the disclosure.

FIG. 11 is a block diagram illustrating an apparatus for prompting in editing a video according to some embodiments of the disclosure.

FIG. 12 is a block diagram illustrating an apparatus for prompting in editing a video according to some embodiments of the disclosure.

FIG. 13 is a block diagram illustrating an apparatus for prompting in editing a video according to some embodiments of the disclosure.

FIG. 14 is a block diagram illustrating an apparatus for prompting in editing a video according to some embodiments of the disclosure.

FIG. 15 is a block diagram illustrating an electronic device according to some embodiments of the disclosure.

### DETAILED DESCRIPTION

In order to enable those of ordinary skill in the art to better understand technical solutions of the disclosure, technical solutions in embodiments of the disclosure will be described clearly and completely as follows with reference to the drawings.

It should be noted that terms “first” and “second” in the specification and claims of the disclosure and the above-mentioned drawings are used to distinguish similar objects, and are not necessarily used to describe a specific sequence or order. It should be understood that data indicated in this way can be interchanged under appropriate circumstances so that the embodiments of the disclosure described herein can be implemented in an order other than those illustrated or described herein. The implementation manners described in the following embodiments do not represent all implementation manners consistent with the disclosure. Rather, they are merely examples of devices and methods consistent with some aspects of the disclosure as detailed in the appended claims.

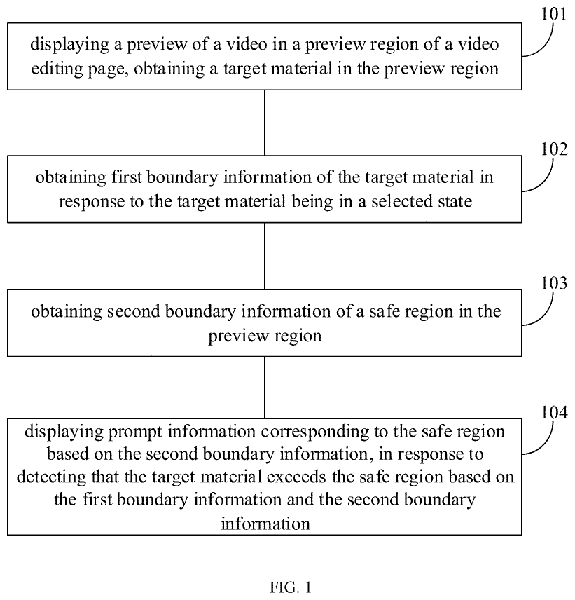

FIG. 1 is a flowchart illustrating a method for prompting in editing a video according to some embodiments of the disclosure. It should be noted that an execution subject of the method for prompting in editing the video according to some embodiments of the disclosure is an apparatus for prompting in editing a video according to some embodiments of the disclosure. The method for prompting in editing the video according to some embodiments of the disclosure may be executed by the apparatus for prompting in editing the video according to some embodiments of the disclosure.

The apparatus may be a hardware device, or software in a hardware device. The hardware device may be a terminal device, a server, etc.

The method as illustrated in FIG. 1 may include the following.

At block 101, the apparatus can display a preview of a video in a preview region of a video editing page, and obtain a target material in the preview region.

The video in the disclosure is a short-form video, i.e., an instant video or an instant music video. For example, the video may be any video with a duration of less than 5 minutes, any video album including at least two photos, any video collection including a plurality of videos and having a total duration of less than 5 minutes, or any video file including at least one photo and at least one video.

It should be noted that the video stored in a local or remote storage area may be obtained, or the video may be recorded directly by the video capturing device. In some embodiments, the video may be retrieved from at least one of a local video library, a local image library, a remote video library and a remote image library, then the video editing page is called, and the preview of the retrieved video is displayed in the preview region of the video editing page. In some embodiments, the video may be recorded directly by the video capturing device, then the video editing page is called in the video capturing device, and the preview of the recorded video is displayed in the preview region of the video editing page. The manner of obtaining the video is not limited in the embodiments of the disclosure, which may be selected based on actual situations.

It should be noted that, it is further determined whether the obtained video meets a condition. The video meets the condition in response to recognizing that the duration of the video is less than or equal to a duration threshold, and then the video editing page is called to edit the video. The video does not meet the condition in response to recognizing that the duration of the video is greater than the duration threshold, the video is cropped or compressed to have a duration less than or equal to the duration threshold, and the video editing page is called to edit the cropped or compressed video. The duration threshold may be set based on actual conditions, for example, the duration threshold may be set to 5 minutes, 60 seconds, etc.

The material in the preview region may be any image material, for example, the image material may be a text material, a sticker, a cover picture, etc. It should be understood that the text material may be a picture with text and bounded by a text box, or an effect picture where text is made into artistic words.

It should be noted that the material as a layer may be stacked on an image (frame) of the video. After confirming and/or saving the modification on the video, the material becomes an inseparable image from the original image of the video. A plurality of layers may be stacked on the same image of the video, that is, a plurality of materials may be stacked on the same image of the video. It should be understood that when stacking a plurality of layers (or materials), an order of stacking the plurality of layers (or materials) may be adjusted and/or changed, that is, when the plurality of materials are utilized, the material that is cast later can block at least part of the material that was cast first. Of course, when the plurality of materials are cast, the plurality of materials may be separated from each other by a certain distance. The mode of displaying among materials is not limited in the embodiments of the disclosure, which may be selected based on actual conditions.

It should be understood that the materials may be displayed in conjunction with the video editing page, that is, buttons for triggering to enter the material selection may be set in the video editing page. The materials may be displayed in the material region when the user triggers the corresponding button. Or some commonly-used materials may be selected, and the commonly-used materials may be displayed in the material region when entering the video editing page.

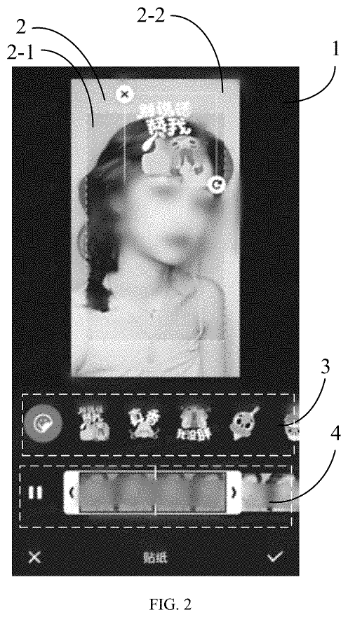

Take a button of triggering sticker materials as an example. As illustrated in FIG. 2, the video editing page 1 includes a preview region 2, a material region 3, and a video bar 4. The material region 3 is a material library selected by the “sticker” button (i.e., the button of triggering sticker materials). The video bar 4 is configured to select, frames that need to add materials, from the video. In other words, there may be a plurality of library buttons on the video editing page 1, one of which is the sticker library button (i.e., the “sticker” button). The user selects the “sticker” button through an operation such as clicking, and the material region 3 displays thumbnails of all materials in the sticker material library.

At block 102, the apparatus can obtain first boundary information of the target material in response to the target material being in a selected state.

In embodiments of the disclosure, when a user adds newly the material into the preview region, the added-newly material may be in the selected state in the preview region by default, and the user may edit the selected material, such as moving position, changing direction, changing size, etc. When the user wants to edit a material that already exists in the preview region, the material may be selected by a target operation on the material. The target operation for the material in the preview region of the video editing page may be set in advance. The material may be determined whether in the selected state through the target operation. In other words, a specific configuration on the material in the preview region of the video editing page may be preset, and a specific operation on the material is defined as the target operation, such as long press, drag, and click.

For example, the material region is arranged horizontally with material controls, and each material control uploads a zoomed material image. When the user selects the material based on the target operation, the material is determined to be selected. For example, when the target operation is a long press, it starts timing when it detects that the user presses any material. When the timer reaches a duration threshold, it is determined that the user's pressing operation meets the target operation of the long press condition. At this time, it is determined that the material is selected. When the target operation is a double click, it starts timing when it detects the user clicks on any material, and the user's click operation on the material is detected again within the preset period of time (for example, 0.1 s), and the material is determined to be selected.

It should be noted that what is displayed in the material region is usually a zoomed image of the material, that is, the original material image is scaled down based on a ratio, so that the size of the reduced image may meet needs of displaying in the material region. However, when the material is stacked on the image of the video, the zoomed image cannot achieve a clear effect, that is, it cannot meet the purpose of a video production user to show the material to video viewers. Therefore, when any material is selected, it needs to be displayed in the preview region in an original state, i.e., in an original size, and the video production user adjusts the size and direction of the selected material based on needs, so as to form the target material after the video production user adjusts the material, and obtain the first boundary information of the target material.

The first boundary information includes distances between boundaries of the material and boundaries of the preview region, or coordinates of vertexes of the material relative to vertexes of the preview region.

It should be understood that distances between boundaries of the material and boundaries of the preview region may be determined by coordinates of boundaries of the material and coordinates of boundaries of the preview region. For example, the abscissa of the lower boundary of the preview region may be set to 0, and coordinates at the leftmost of the lower boundary of the preview region may be (0, 0). At this time, the first boundary information of the lower boundary of the material may be an absolute value of the ordinate of the lower boundary of the material. For example, the lower boundary of the material has a distance from the lower boundary of the preview region by five lines. Therefore, the distance between the lower boundary of the material and the lower boundary of the preview region is 5, that is, the first boundary information of the lower boundary of the material is 5. Similarly, according to this rule, the first boundary information of the left boundary of the material may be obtained, the first boundary information of the right boundary of the material may be obtained, and the first boundary information of the upper boundary of the material may be obtained.

It should also be understood that when any material is selected, the material may be displayed in the preview region, that is, the effect of superimposing the material on the surface of the image of the video is shown to the video production user. The video production user may adjust the material in the preview region based on the superimposing effect, such as adjusting the size, direction, and position of the material. The first boundary information may be determined based on coordinates of the boundary positions of the adjusted material.

At block 103, the apparatus can obtain second boundary information of a safe region in the preview region.

It should be noted that some regions of the video need to be occupied by the operating region of a video playing page when the video is played in the video playing page. Therefore, when the materials are added during editing the video into these regions occupied during playing the video, the added materials may not be completely displayed when the video is played actually to the video viewers. That is, the purpose of adding the materials by the video production user cannot be achieved. Even more, these regions occupied are usually used for video viewers to input text or interact with other video viewers and the video production user. When the materials are added into these occupied regions, it may also easily affect the interactive experience of the video viewers.

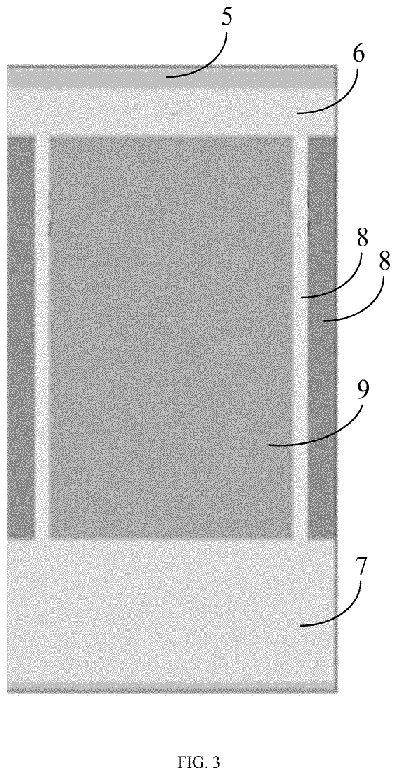

For example, as illustrated in FIG. 3, during playing the video, a video playing interface 5 on the video viewer's terminal may include a plurality of regions, such as a top bar operating region 6, an avatar comment region 7, cutting regions 8, margins 8, and a safe region 9.

Therefore, in the process of editing the video, the preview of the video in the video editing page needs to be divided into regions based on the state of the video when the video is played, to form the safe region in the video editing page, that is, the safe region 2-1 as illustrated in FIG. 2.

The second boundary information includes distances between boundaries of the safe region and boundaries of the preview region, or coordinates of vertexes of the safe region relative to vertexes of the preview region.

It should be understood that distances between boundaries of the safe region and boundaries of the preview region may be determined by coordinates of boundaries of the safe region and coordinates of boundaries of the preview region. For example, the abscissa of the lower boundary of the preview region may be set to 0, and coordinates at the leftmost of the lower boundary of the preview region may be (0, 0). At this time, the second boundary information of the lower boundary of the safe region may be an absolute value of the ordinate of the lower boundary of the safe region. For example, the lower boundary of the safe region has a distance from the lower boundary of the preview region by three lines. Therefore, the distance between the lower boundary of the safe region and the lower boundary of the preview region is 3, that is, the second boundary information of the lower boundary of the safe region is 3. Similarly, according to this rule, the second boundary information of the left boundary of the safe region may be obtained, the second boundary information of the right boundary of the safe region may be obtained, and the second boundary information of the upper boundary of the safe region may be obtained.

At block 104, the apparatus can display prompt information corresponding to the safe region based on the second boundary information, in response to detecting that the target material exceeds the safe region based on the first boundary information and the second boundary information.

It detects that the material exceeds the safe region based on the first boundary information and the second boundary information. That is, it detects that the material exceeds the safe region based on distances between boundaries of the material and boundaries of the preview region, and distances between boundaries of the safe region and boundaries of the preview region; or it detects that the material exceeds the safe region based on coordinates of vertexes of the material relative to vertexes of the preview region, and coordinates of vertexes of the safe region relative to vertexes of the preview region.

When it detects that the material exceeds the safe region based on distances between boundaries of the material and boundaries of the preview region, and distances between boundaries of the safe region and boundaries of the preview region, it may detect that the material exceeds the safe region in response to distances between boundaries of the material and boundaries of the preview region being less that distances between boundaries of the safe region and boundaries of the preview region. In other words, it may detect that the material exceeds the safe region in response to a distance between any one of boundaries of the material and the corresponding boundary of the preview region, being less than, a distance between the corresponding boundary of the safe region and the corresponding boundary of the preview region. For example, when the distance between the upper boundary of the material and the upper boundary of the preview region is 2, and the distance between the upper boundary of the safe region and the upper boundary of the preview region is 3, it may detect that the material exceeds the safe region because 2<3.

When it detects that the material exceeds the safe region based on coordinates of vertexes of the material relative to vertexes of the preview region, and coordinates of vertexes of the safe region relative to vertexes of the preview region, it may detect that the material exceeds the safe region in response to coordinates of vertexes of the material relative to vertexes of the preview region being less than coordinates of vertexes of the safe region relative to vertexes of the preview region. For example, the ordinate representing the highest point of the material in the first boundary information is greater than the ordinate representing the highest point of the safe region in the second boundary information, the ordinate representing the lowest point of the material in the first boundary information is smaller than the ordinate representing the lowest point of the safe region in the second boundary information, the abscissa representing the left vertex of the material in the first boundary information is smaller than the abscissa representing the left vertex of the safe region in the second boundary information, or the abscissa representing the right vertex of the material in the first boundary information is greater than the abscissa representing the right vertex of the safe region.

The prompt information may prompt the user that the material currently set in the image of the video cannot be completely displayed to the video viewer when the video is played.

With the method for prompting in editing the video provided in embodiments of the disclosure, during the process of editing the video and when the material is selected, if it is determined that the material exceeds the safe region based on the first boundary information of the material in the preview region and the second boundary information of the safe region in the preview region, the prompt information corresponding to the safe region is displayed based on the second boundary information. Therefore, the disclosure may detect and identify the first boundary information of the material in the preview region and the second boundary information of the safe region in the preview region, may accurately determine that the material exceeds the safe region based on the first and second boundary information, and display the prompt information corresponding to the safe region based on the second boundary information, so that the video production user may adjust the position of the material based on the prompt information, so as to edit the effect that is more in line with the video production user's expectations during the video is played.

It should be noted that videos captured by video capturing devices have different aspect ratios due to different sensors in the video capturing devices. That is, the aspect ratio of the video relates to the video capturing device. Furthermore, screens of video playing devices commonly used by video viewers, such as mobile terminals, also have different aspect ratios due to different models. Therefore, if the video playing device used by the video viewer has the same aspect ratio as the video capturing device used by the video production user, the video viewer can better watch the complete video. If the video playing device used by the video viewer has the different aspect ratio as the video capturing device used by the video production user, the problem of incomplete displaying the produced video is prone to occur. Therefore, when the video production user edits the video, the safe region needs to be determined, so that the content edited in the safe region can meet viewing needs of users who use video playing devices with any aspect ratio.

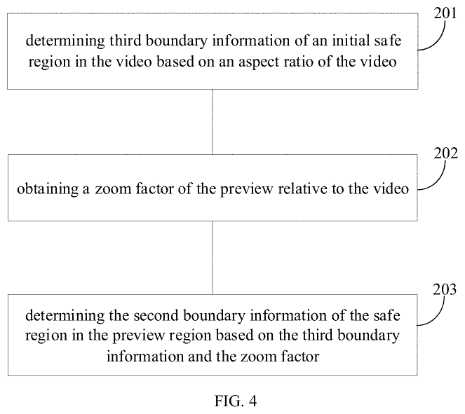

In some embodiments, as illustrated in FIG. 4, obtaining the second boundary information of the safe region in the preview region in block 103 may include the following.

At block 201, the apparatus can determine third boundary information of an initial safe region in the video based on an aspect ratio of the video.

In some embodiments, under a case that the aspect ratio of the video is not lower than a ratio threshold, the third boundary information of the initial safe region in the video is determined based on the aspect ratio of the video; and under a case that the aspect ratio of the video is lower than the ratio threshold, there is no initial safe region in the video.

The third boundary information includes distances between boundaries of the initial safe region and boundaries of the preview region, or coordinates of vertexes of the initial safe region relative to vertexes of the preview region.

In other words, when the aspect ratio of the video is small, for example, when the aspect ratio of the video is lower than the ratio threshold, it means that the video can be completed played by most playing devices that can play short-form videos. That is, when the user is watching the video (regardless of whether the editing has been completed or not), images of the video usually exist in the safe region, i.e., when the video is played, the top bar operating region, the avatar comment region, the cutting regions and the margins will not affect the images of the video. No matter where the material is applied to the image of the video, it can be complete played when the video is played. Therefore, when the aspect ratio of the video is lower than the ratio threshold, it is determined that there is no initial safe region in the video, and the images of the entire video are safe, and no cropping is required.

Or, when the aspect ratio of the video is not lower than the ratio threshold, it means that when the video is played, the top bar operating region, the avatar comment region, the cutting regions and the margins will also display the images of the video because the images of the video is bigger. That is, if the material is placed in the position corresponding to the top bar operating region, the avatar comment region, the cutting regions and the margins, it will not meet the viewing needs of users who watch the video. Therefore, it is necessary to crop the best playing region (the safe region in the preview region) of the video during editing the video.

In some embodiments, determining the third boundary information of the initial safe region in the video based on the aspect ratio of the video includes: determining an aspect ratio range belonged by the aspect ratio; determining a first percentage and a second percentage corresponding to the aspect ratio range; and determining the third boundary information of the initial safe region based on the first percentage and the second percentage.

The first percentage is a ratio of a height of the initial safe region to a height of the video, and the second percentage is a ratio of a width of the initial safe region to a width of the video.

It should be noted that the screen sizes of mobile terminals have a richer diversity, such as 6-inch screens, 6.1-inch screens, 6.58-inch screens, etc. In order to ensure that any video playing device can be better to achieve the selection of the initial safe region, the disclosure divides the various aspect ratios of videos into a plurality of aspect ratio ranges. Then, when the video production user edits the video, the aspect ratio range to which the aspect ratio of the video belongs is determined based on the actual situation of the video.

For example, in the disclosure, the aspect ratios can be divided into three ranges. When the actual aspect ratio of the video is greater than the ratio threshold and less than or equal to a first range threshold, the actual aspect ratio of the video is determined in a first aspect ratio range. When the actual aspect ratio of the video is greater than the first range threshold and less than or equal to a second range threshold, the actual aspect ratio of the video is determined in a second aspect ratio range. When the actual aspect ratio of the video is greater than the second range threshold, the actual aspect ratio of the video is determined in a third aspect ratio range.

The aspect ratio of the video has a negative correlation with the first percentage, and has a positive correlation with the second percentage.

In other words, as the aspect ratio of the video gradually increases, the first percentage (the ratio of the height of the initial safe region to the height of the video) gradually decreases or remains unchanged. As the aspect ratio of the video gradually increases, the second percentage (the ratio of the width of the initial safe region to the width of the video) gradually increases or remains unchanged.

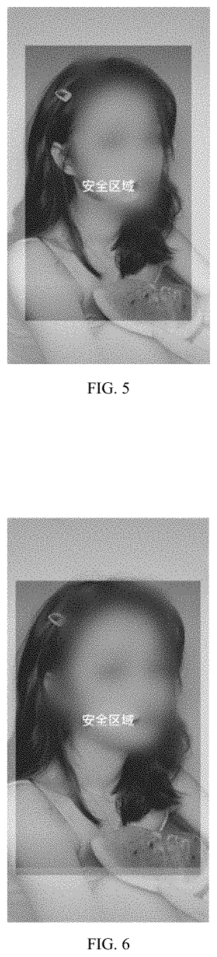

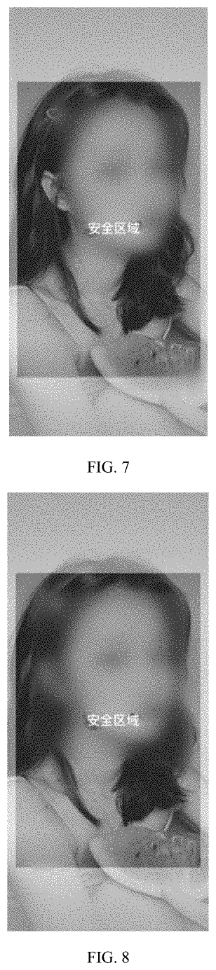

For example, the ratio threshold may be set to 16:9, the first range threshold may be set to 18:9, and the second range threshold may be set to 19:9. When the aspect ratio of the video is in the first aspect ratio range greater than 16:9 and less than or equal to 18:9, it is determined that the first percentage corresponding to the first aspect ratio range is 91% and the second percentage corresponding to the first aspect ratio range is 68%, as illustrated in FIG. 5. When the aspect ratio of the video is in the second aspect ratio range greater than 18:9 and less than or equal to 19:9, it is determined that the first percentage corresponding to the second aspect ratio range is 91% and the second percentage corresponding to the second aspect ratio range is 65%, as illustrated in FIG. 6. When the aspect ratio of the video is in the third aspect ratio range greater than 19:9, it is determined that the first percentage corresponding to the third aspect ratio range is 91% and the second percentage corresponding to the third aspect ratio range is 63%, as illustrated in FIG. 7. When the aspect ratio of the video is equal to the ratio threshold, the first percentage may be 82%, and the second percentage may be 75%, as illustrated in FIG. 8.

In other words, the disclosure may determine the percentages of the initial safe region corresponding to the video occupying the entire image of the video by the aspect ratio of the video, that is, the proportions of the safe region during the video is played in the entire image of the video. The initial safe region may be determined in the middle of the image of the video based on the determined percentages of the initial safe region, and the distances between boundaries of the initial safe region and boundaries of the preview region, or coordinates of vertexes of the initial safe region relative to vertexes of the preview region may be determined as the third boundary information.

At block 202, the apparatus can obtain a zoom factor of the preview relative to the video.

It should be noted that the video needs to be zoomed and displayed in the preview region of the editing page, so that other regions of the editing page can be set with editing controls such as the material region and the video bar region. Therefore, when editing the video, it is necessary to obtain the zoom factor of the preview of the video in the preview region of the video editing page relative to the video.

At block 203, the apparatus can determine the second boundary information of the safe region in the preview region based on the third boundary information and the zoom factor.

Based on the foregoing analysis, it can be seen that the initial safe region can be the safe region when the video is played. During editing the video, the video is zoomed on the video editing page to form the preview. Therefore, based on the third boundary range of the initial safe region and the zoom factor, the second boundary information of the safe region in the preview region is determined, i.e., the third boundary information is also adjusted based on the zoom ratio.

It should be understood that, as some embodiments, the preview is first obtained based on the zoom ratio, and the second boundary information is determined based on the first percentage and second percentage determined based on the aspect ratio of the preview.

That is to say, the size of the safe region is related to the aspect ratio of the video and the zoom ratio of the preview, and there is no specific limitation on the order of ratio calculation.

Therefore, with the method for prompting in editing the video according to the disclosure, the safe region of the video suitable for different aspect ratios may be selected through the aspect ratio of the video and the zoom ratio of the preview, so that the prompt operation when the material exceeds the safe region may meet various standards of videos, thereby further ensuring the needs of the video production user, and at the same time ensuring the viewing experience of the video viewers.

It should be noted that after it has been identified that the material exceeds the safe region, if the video production user is allowed to continue to adjust the position of the material, it will seriously affect the viewing experience of the video viewers. Therefore, it is necessary to tell the video production user about the inappropriate locations of placing the material.

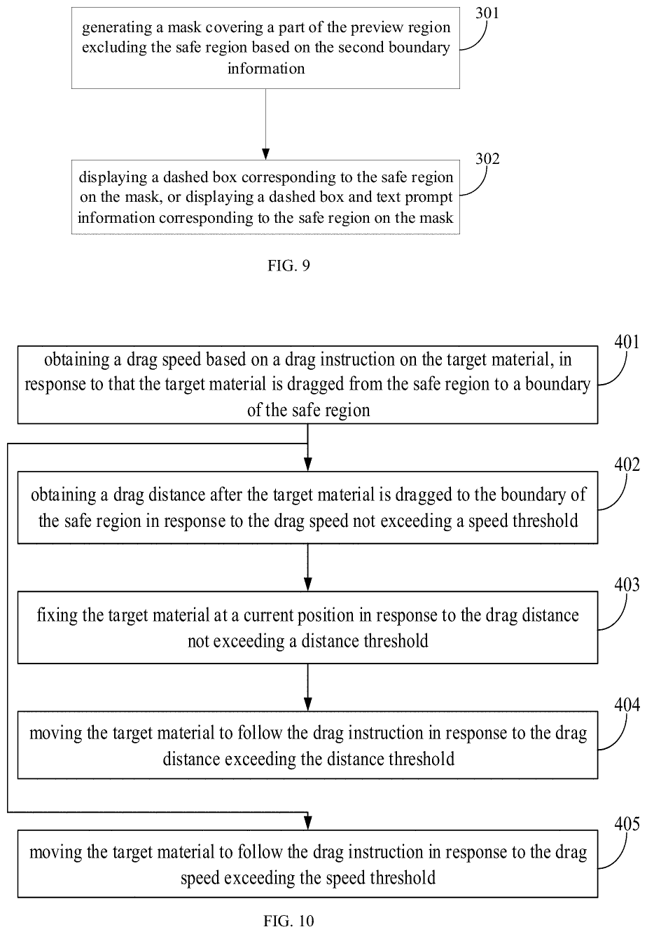

In some embodiment, as illustrated in FIG. 9, displaying the prompt information corresponding to the safe region based on the second boundary information at block 104 may include the following.

At block 301, the apparatus can generate a mask covering a part of the preview region excluding the safe region based on the second boundary information.

The masking may be a semi-transparent layer that has the effect of occluding the content of the currently edited image of the video. For example, the masking may have a transparency of 20%-80%.

At block 302, the apparatus can display a dashed box corresponding to the safe region on the mask, or a dashed box and text prompt information corresponding to the safe region on the mask.

It should be noted that the part of the preview region excluding the safe region is set with the mask, that is, the outer region corresponding to the second boundary information is covered with the mask. As a result, the non-safe region in the preview region is blocked, so that the video production user can clearly feel that if the video is played, the region covered by the mask cannot be effectively viewed by the video viewers. At this time, the dashed box corresponding to the safe region can also be displayed on the mask, or text prompt information corresponding to the safe region is displayed on the mask, or the dashed box and text prompt information corresponding to the safe region is displayed on the mask, so as to give the video production user an obvious reminder of the scope of the safe region to make the video production can clearly feel the boundary between the safe region and the non-safe region. Therefore, the safe region where the material can be cast can be accurately known without fumbling on the locations of casting the material.

For example, after the user triggers the control loaded with the material to cast the material uploaded by the control into the preview region, the video editing device obtains the first boundary information of the material and the second boundary information of the safe region in the preview region. After that, the video production user can adjust the position of the material by dragging, sliding, etc., and the video editing device monitors the relationship between the first boundary information and the second boundary information in real time to determine whether the material exceeds the safe region. When the material exceeds the safe region, for example, the abscissa of the right edge of the material is greater than the abscissa of the right edge of the safe region, the non-safe region in the preview region will be covered with the mask, as the mask 2-2 illustrated in FIG. 2, thereby reducing the transparency of the non-safe region. Therefore, the video production user feels that the video viewers cannot clearly watch the current material while the video is playing. At the same time, the dashed box corresponding to the safe region may be displayed in the mask to remind the video production user that the region (i.e., safe region) that the material can be clearly viewed during the video is played. In addition, in order to allow the video editing user to be able to more clearly understand the meaning of the aforementioned mask and dashed box, text prompts may be directly given in the safe region, such as displaying the “best visual region” and “best viewing region” in the safe region, so that the video production user can clarify that the content in this region has the best playing effect during the video is played. The specific text settings are not specifically limited in the disclosure.

In some embodiments, the prompt information corresponding to the safe region is not displayed in response to that the material is located in the safe region.

In other words, if the video editing device monitors the relationship between the first boundary information and the second boundary information in real time, it determines that the boundary of the material does not exceed the safe region. That is, coordinates in the first boundary information satisfy: the abscissa of the left boundary of the material is greater than the abscissa of the left boundary of the safe region, the abscissa of the right boundary of the material is smaller than the abscissa of the right boundary of the safe region, the ordinate of the upper boundary of the material is smaller than the ordinate of the upper boundary of the safe region, and the ordinate of the lower boundary of the material is greater than the ordinate of the lower boundary of the safe region. At this time, there is no need to display the prompt information corresponding to the safe region. That is, the visual effect of this region is not explained to the video production user, so as not to affect the attention of the video production user due to more content in the preview region.

It should be understood that if the material is located in the safe region, the mask and the dashed box for prompting the safe region and the text prompt information are not displayed to ensure the viewing effect of the video when the video production user edits the video.

In some embodiments, the prompt information corresponding to the safe region is not displayed in response to that the material is in an unselected state

It should be understood that the unselected state of the material means that none of the materials in the preview region is not selected. For example, the editing of the previous material is fixed by means of saving and/or confirming and no new material has been edited. At this time, in order to enable the video production user to better observe the content of the image of the video to select more suitable materials, the prompt information of the safe region may not be displayed.

It should be understood that when there is no material in the preview region, for example, the video editing is initial and the material has not been edited. Another example is that the video production user uses the close button and/or return function to set the material to be not cast when the material is applied to the preview region, and the prompt information corresponding to the safe region is not displayed when the new material has not been edited yet.

Furthermore, due to the increasing popularity of viewing and production of short-from videos, as well as the home isolation caused by, for example, COVID-19, the short-from videos have attracted a large number of older users. For example, many elderly people share the short-from videos to show their progress during the outbreak. However, such people usually have physical defects such as eyesight. Therefore, “display” prompts such as masking, dashed box, and text prompts are usually unable to prompt video production users in time. The disclosure also increases the damping of moving the material to provide a certain resistance to the moving material, and the video editing user may realize that the current moving may produce undesirable visual effects.

In some embodiments, as illustrated in FIG. 10, the method further includes the following.

At block 401, the apparatus can obtain a drag speed based on a drag instruction on the target material, in response to that the target material is dragged from the safe region to a boundary of the safe region.

At block 402, the apparatus can obtain a drag distance after the target material is dragged to the boundary of the safe region in response to the drag speed not exceeding a speed threshold.

It should be noted that, based on research on human behavior, when video production users editing videos, they need to consider a plurality of adjustments such as the position, angle and size of the material, and it will make the user's finger to drag the material slower. Therefore, the disclosure detects the drag speed of the user's finger to determine whether the current drag action of the user is setting the position of the material. That is, when the drag speed of the user's finger does not exceed the speed threshold, it is determined that the user's current drag action is a setting action for the position of the material, and then the drag distance of the user's finger after the material is moved to the boundary of the safe region is detected.

At block 403, the apparatus can fix the target material at a current position in response to the drag distance not exceeding a distance threshold.

At block 404, the apparatus can move the target material to follow the drag instruction in response to the drag distance exceeding the distance threshold.

It should be understood that due to the delay of the drag instruction (formed by the drag action and the size of the user's finger) and the drag action, the delay of converting the user's visual observation to the stop of the drag action, etc., the user's finger is still dragging to outside the safe region even after the material has been dragged to the boundary of the safe region. Therefore, it is necessary to further determine whether the user's drag action is a misoperation due to the delay or the user's active drag behavior, based on the drag distance of the user's finger.

That is, when the user drags the material in the safe region, the position of the material gradually moves from the inside of the safe region to the boundary of the safe region, and then the drag distance of the user's finger starts from the boundary of the safe region and gradually increase. When the drag distance of the user's finger does not exceed the distance threshold, the drag action that occurs after the material moves to the boundary of the safe region is considered to be a misoperation caused by the delay. At this time, the material is controlled to be fixed at the current position, that is, the material does not continue to move with the drag action, thereby prompting the user that the material has reached the boundary of the safe region. If it continues to move, it will affect the video viewers' viewing experience on the material.

After the material is fixed, if the drag distance of the user's finger continues to increase, it is considered that the user insists on moving the material out of the safe region, and then the material is controlled to follow the drag instruction to move.

It should be understood that the above operations usually occur when the video editing user selects a plurality of materials. That is, the video editing user wants to cast one material at a certain position but selects at least two materials. At this time, the user usually may select one material to drag to the target position, and then move it away, for example, move out of the safe region to leave the entire region of the safe region for the second material, and then drag the second material to the target position, so as to select the target material based on the two casting effects.

At block 405, the apparatus can move the target material to follow the drag instruction in response to the drag speed exceeding the speed threshold.

It should be understood that when people move their fingers faster, they usually do not have certainty of the target position. That is, the target position of the movement cannot be ascertained. The approximate region of the movement can be known, but it cannot be used as the movement to the vertex of the target position. Therefore, if the drag speed of the user's finger exceeds the speed threshold, the user's current operation is considered to clear the redundant material in the safe region. That is, the operation is only to drag the material out of the safe region but not to drag the material to a certain target position. Therefore, the material is controlled to move with the drag instruction.

Therefore, with the method for prompting in editing the video proposed in the disclosure, the purpose of the user's drag behavior may be identified based on the user's drag speed on the material. Therefore, when the user drags and releases the material, the current position is maintained and cannot be easily dragged to realize the purpose of prompting the user automatically, so as to avoid the problem that the user cannot obtain the prompt information of the display type in time, which may cause the video editing to not meet the user's needs, and effectively improves the user's experience of the video editing process.

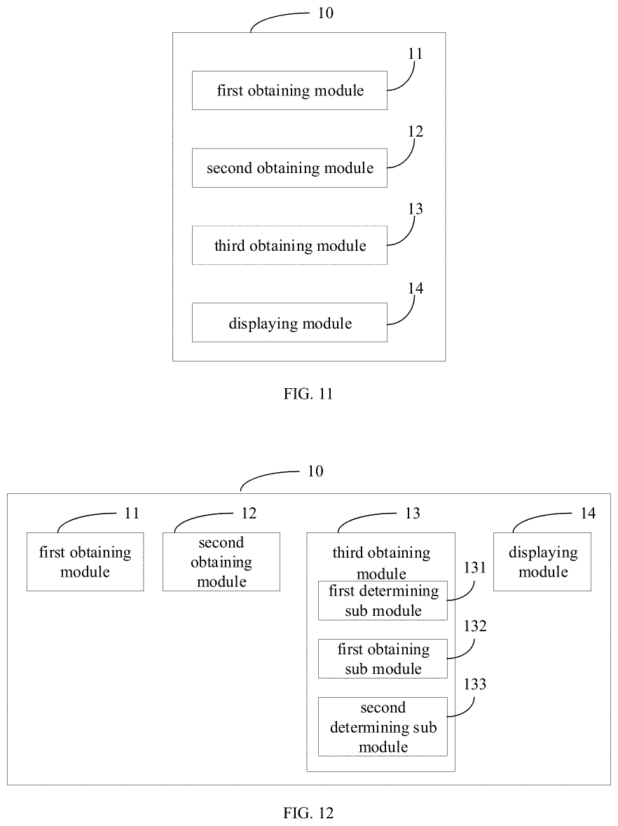

FIG. 11 is a block diagram illustrating an apparatus for prompting in editing a video.

As illustrated in FIG. 11, the apparatus 10 includes a first obtaining module 11, a second obtaining module 12, a third obtaining module 13, and a displaying module 14.

The first obtaining module 11 is configured to display a preview of a video in a preview region of a video editing page and obtain a material in the preview region.

The second obtaining module 12 is configured to obtain first boundary information of the material in response to the material being in a selected state.

The third obtaining module 13 is configured to obtain second boundary information of a safe region in the preview region.

The displaying module 14 is configured to display prompt information corresponding to the safe region based on the second boundary information, in response to detecting that the material exceeds the safe region based on the first boundary information and the second boundary information.

In some embodiments, as illustrated in FIG. 12, the third obtaining module 13 includes a first determining sub module 131, a first obtaining sub module 132, and a second determining sub module 133. The first determining sub module 131 is configured to determine third boundary information of an initial safe region in the video based on an aspect ratio of the video. The first obtaining sub module 132 is configured to obtain a zoom factor of the preview relative to the video. The second determining sub module 133 is configured to determine the second boundary information of the safe region in the preview region based on the third boundary information and the zoom factor.

In some embodiments, the first determining sub module 131 includes a first determining unit and a second determining unit. The first determining unit is configured to determine the third boundary information of the initial safe region in the video based on the aspect ratio of the video in response to the aspect ratio of the video being not lower than a ratio threshold. The second determining unit is configured to determine that there is no initial safe region in the video in response to the aspect ratio of the video being lower than the ratio threshold.

In some embodiments, the first determining unit includes a first determining sub unit, a second determining sub unit, and a third determining sub unit. The first determining sub unit is configured to determine an aspect ratio range belonged by the aspect ratio. The second determining sub unit is configured to determine a first percentage and a second percentage corresponding to the aspect ratio range, the first percentage being a ratio of a height of the initial safe region to a height of the video, the second percentage being a ratio of a width of the initial safe region to a width of the video. The third determining sub unit is configured to determine the third boundary information of the initial safe region based on the first percentage and the second percentage.

In some embodiments, the aspect ratio of the video has a negative correlation with the first percentage, and has a positive correlation with the second percentage.

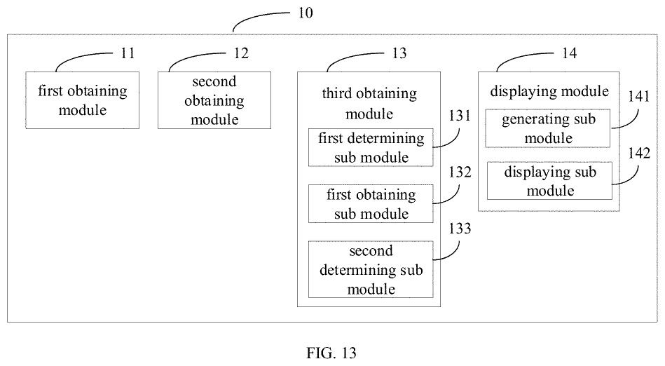

In some embodiments, as illustrated in FIG. 13, the displaying module 14 includes a generating sub module 141 and a displaying sub module 142. The generating sub module 141 is configured to generate a mask covering a part of the preview region excluding the safe region based on the second boundary information. The displaying sub module 142 is configured to display a dashed box corresponding to the safe region on the mask, or displaying a dashed box and text prompt information corresponding to the safe region on the mask.

In some embodiments, the displaying module 14 is configured to not display the prompt information corresponding to the safe region in response to the material being located in the safe region.

In some embodiments, the displaying module 14 is configured to not display the prompt information corresponding to the safe region in response to the material being in an unselected state.

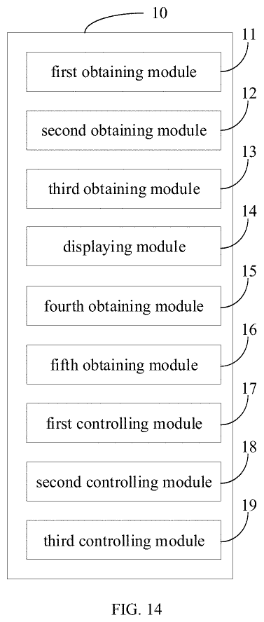

In some embodiments, as illustrated in FIG. 14, the apparatus further includes a fourth obtaining module 15, a fifth obtaining module 16, and a first controlling module 17.

The fourth obtaining module 15 is configured to obtain a drag speed in response to that the material is dragged from the safe region to a boundary of the safe region.

The fifth obtaining module 16 is configured to obtain a drag distance after the material is dragged to the boundary of the safe region in response to the drag speed not exceeding a speed threshold.

The first controlling module 17 is configured to fix the material at a current position in response to the drag distance not exceeding a distance threshold.

In some embodiments, as illustrated in FIG. 14, the apparatus further includes a second controlling module 18. The second controlling module 18 is configured to move the material to follow a drag instruction in response to the drag distance exceeding the distance threshold.

In some embodiments, as illustrated in FIG. 14, the apparatus further includes a third controlling module 19. The third controlling module 19 is configured to move the material to follow a drag instruction in response to the drag speed exceeding the speed threshold.

In some embodiments, the first boundary information includes distances between boundaries of the material and boundaries of the preview region, or coordinates of vertexes of the material relative to vertexes of the preview region; the second boundary information includes distances between boundaries of the safe region and boundaries of the preview region, or coordinates of vertexes of the safe region relative to vertexes of the preview region; and the third boundary information includes distances between boundaries of the initial safe region and boundaries of the preview region, or coordinates of vertexes of the initial safe region relative to vertexes of the preview region.

Regarding the apparatus according to the foregoing embodiments, the specific manner in which each module performs operations has been described in detail in embodiments of the method, and thus detailed description will not be repeated here.

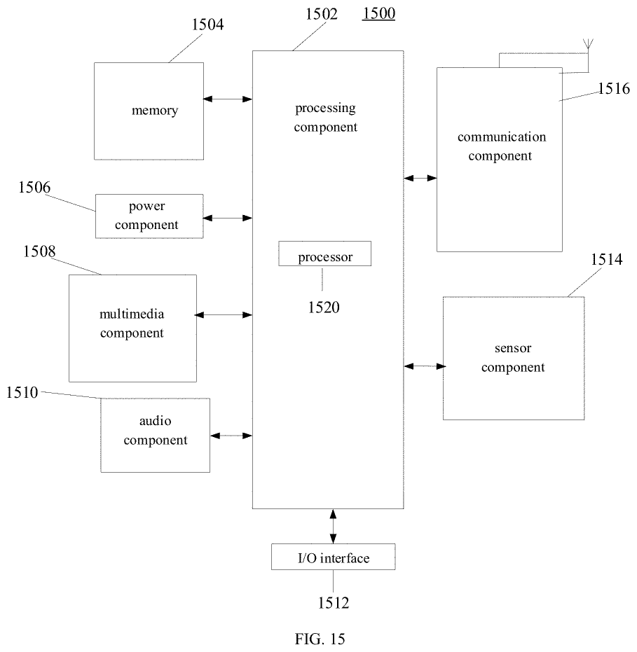

FIG. 15 is a block diagram illustrating an electronic device 1500 according to some embodiments. For example, the device 1500 may be a mobile phone, a computer, a digital broadcast terminal, a messaging device, a game console, a tablet device, a medical device, an exercise device, a personal digital assistant, and the like.

Referring to FIG. 15, the device 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 normally controls the overall operation (such as operations associated with displaying, telephone calls, data communications, camera operations and recording operations) of the device 1500. The processing component 1502 may include one or more processors 1520 to execute instructions so as to perform all or part of the actions of the above described method.

In addition, the processing component 1502 may include one or more units to facilitate interactions between the processing component 1502 and other components. For example, the processing component 1502 may include a multimedia unit to facilitate interactions between the multimedia component 1508 and the processing component 1502.

The memory 1504 is configured to store various types of data to support operations at the device 1500. Examples of such data include instructions for any application or method operated on the device 1500, contact data, phone book data, messages, images, videos and the like. The memory 1504 may be realized by any type of volatile or non-volatile storage devices, or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or an optical disk.

The power component 1506 provides power to various components of the device 1500. The power component 1506 may include a power management system, one or more power sources and other components associated with power generation, management, and distribution of the device 1500.

The multimedia component 1508 includes a screen that provides an output interface between the device 1500 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may sense not only the boundary of the touches or sliding actions, but also the duration and pressure related to the touches or sliding operations. In some embodiments, the multimedia component 1508 includes a front camera and/or a rear camera. When the device 1500 is in an operation mode such as a shooting mode or a video mode, the front camera and/or the rear camera may receive external multimedia data. Each front camera and rear camera may be a fixed optical lens system or have a focal length and an optical zoom capability.

The audio component 1510 is configured to output and/or input an audio signal. For example, the audio component 1510 includes a microphone (MIC) that is configured to receive an external audio signal when the device 1500 is in an operation mode such as a call mode, a recording mode, and a voice recognition mode. The received audio signal may be further stored in the memory 1504 or transmitted via the communication component 1516. In some embodiments, the audio component 1510 further includes a speaker for outputting audio signals.

The I/O interface 1512 provides an interface between the processing component 1502 and a peripheral interface unit. The peripheral interface unit may be a keyboard, a click wheel, a button and so on. These buttons may include, but are not limited to, a home button, a volume button, a start button, and a locking button.

The sensor component 1514 includes one or more sensors for providing the device 1500 with various aspects of status assessments. For example, the sensor component 1514 may detect an ON/OFF state of the device 1500 and a relative positioning of the components. For example, the components may be a display and a keypad of the device 1500. The sensor component 1514 may also detect a change in position of the device 1500 or a component of the device 1500, the presence or absence of contact of the user with the device 1500, the orientation or acceleration/deceleration of the device 1500 and a temperature change of the device 1500. The sensor component 1514 may include a proximity sensor configured to detect the presence of nearby objects without any physical contact. The sensor component 1514 may also include a light sensor (such as a CMOS or a CCD image sensor) for use in imaging applications. In some embodiments, the sensor component 1514 may further include an acceleration sensor, a gyro sensor, a magnetic sensor, a pressure sensor, or a temperature sensor.

The communication component 1516 is configured to facilitate wired or wireless communication between the device 1500 and other devices. The device 1500 may access a wireless network based on a communication standard such as 2G, 3G, 4G, 5G or a combination thereof. In some embodiments, the communication component 1516 receives broadcast signals or broadcast-associated information from an external broadcast management system via a broadcast channel. In some embodiments, the communication component 1516 further includes a near field communication (NFC) module to facilitate short range communication. For example, the NFC module may be implemented based on radio frequency identification (RFID) technology, infrared data association (IrDA) technology, ultra-wide band (UWB) technology, Bluetooth (BT) technology and other technologies.

In some embodiments, the device 1500 may be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, or other electronic components, so as to perform the above image conversion method.

In some embodiments, there is also provided a non-transitory computer readable storage medium including instructions, such as a memory 1504 including instructions. The instructions are executable by the processor 1520 of the device 1500 to perform the above method. For example, the non-transitory computer readable storage medium may be a ROM, a random-access memory (RAM), a CD-ROM, a magnetic tape, a floppy disk, an optical data storage device, etc.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for prompting in editing a video, comprising:
displaying a preview of a video in a preview region of a video editing page;
obtaining a target material in the preview region;
obtaining first boundary information of the target material in response to the target material being in a selected state;
obtaining second boundary information of a safe region in the preview region; and
displaying prompt information corresponding to the safe region based on the second boundary information, in response to detecting that the target material exceeds the safe region based on the first boundary information and the second boundary information.

2. The method according to claim 1, said obtaining the second boundary information of the safe region in the preview region comprising:
determining third boundary information of an initial safe region in the video based on an aspect ratio of the video;
obtaining a zoom factor of the preview relative to the video; and
determining the second boundary information based on the third boundary information and the zoom factor.

3. The method according to claim 2, said determining the third boundary information of the initial safe region in the video based on the aspect ratio of the video comprising:
determining the third boundary information based on the aspect ratio in response to the aspect ratio being not lower than a ratio threshold; and
determining the video not including the initial safe region in response to the aspect ratio being lower than the ratio threshold.

4. The method according to claim 3, said determining the third boundary information based on the aspect ratio comprising:
determining an aspect ratio range of the aspect ratio;
determining a first percentage and a second percentage based on the aspect ratio range, the first percentage being a ratio of a height of the initial safe region to a height of the video, the second percentage being a ratio of a width of the initial safe region to a width of the video; and
determining the third boundary information based on the first percentage and the second percentage.

5. The method according to claim 4, wherein the aspect ratio is correlated with the first percentage negatively, and correlated with the second percentage positively.

6. The method according to claim 1, said displaying the prompt information corresponding to the safe region based on the second boundary information comprising:
generating a mask covering a part of the preview region excluding the safe region based on the second boundary information; and
displaying a dashed box and/or text prompt information corresponding to the safe region on the mask.

7. The method according to claim 1, further comprising:
obtaining a drag speed based on a drag instruction on the target material, in response to that the target material is dragged from the safe region to a boundary of the safe region;
obtaining a drag distance after the target material is dragged to the boundary of the safe region in response to the drag speed not exceeding a speed threshold; and
fixing the target material at a current position in response to the drag distance not exceeding a distance threshold.

8. The method according to claim 7, further comprising:
moving the target material to follow the drag instruction in response to the drag speed exceeding the speed threshold; or
moving the target material to follow the drag instruction in response to the drag distance exceeding the distance threshold.

9. The method according to claim 2, wherein,
the first boundary information comprises distances between boundaries of the target material and boundaries of the preview region, or coordinates of vertexes of the target material relative to vertexes of the preview region;
the second boundary information comprises distances between boundaries of the safe region and boundaries of the preview region, or coordinates of vertexes of the safe region relative to vertexes of the preview region; and
the third boundary information comprises distances between boundaries of the initial safe region and boundaries of the preview region, or coordinates of vertexes of the initial safe region relative to vertexes of the preview region.

10. An electronic device, comprising:
a processor; and
a storage device for storing executable instructions,
wherein the processor is configured to execute the executable instructions to:
display a preview of a video in a preview region of a video editing page;
obtain a target material in the preview region;
obtain first boundary information of the target material in response to the target material being in a selected state;
obtain second boundary information of a safe region in the preview region; and
display prompt information corresponding to the safe region based on the second boundary information, in response to detecting that the target material exceeds the safe region based on the first boundary information and the second boundary information.

11. The electronic device as claimed in claim 10, wherein the executable instructions comprise instructions to cause the processor to:
determine third boundary information of an initial safe region in the video based on an aspect ratio of the video;
obtain a zoom factor of the preview relative to the video; and
determine the second boundary information based on the third boundary information and the zoom factor.

12. The electronic device as claimed in claim 11, wherein the executable instructions comprise instructions to cause the processor to:
determine the third boundary information based on the aspect ratio in response to the aspect ratio being not lower than a ratio threshold; and
determine that there is no initial safe region in the video in response to the aspect ratio being lower than the ratio threshold.

13. The electronic device as claimed in claim 12, wherein the executable instructions comprise instructions to cause the processor to:
determine an aspect ratio range of the aspect ratio;
determine a first percentage and a second percentage based on the aspect ratio range, the first percentage being a ratio of a height of the initial safe region to a height of the video, the second percentage being a ratio of a width of the initial safe region to a width of the video; and
determine the third boundary information based on the first percentage and the second percentage.

14. The electronic device as claimed in claim 10, wherein the executable instructions comprise instructions to cause the processor to:
generate a mask covering a part of the preview region excluding the safe region based on the second boundary information; and
display a dashed box corresponding to the safe region on the mask, or displaying a dashed box and text prompt information corresponding to the safe region on the mask.

15. The electronic device as claimed in claim 10, wherein the executable instructions comprise instructions to cause the processor to:
obtain a drag speed based on a drag instruction on the target material, in response to that the target material is dragged from the safe region to a boundary of the safe region;
obtain a drag distance after the target material is dragged to the boundary of the safe region in response to the drag speed not exceeding a speed threshold; and
fix the target material at a current position in response to the drag distance not exceeding a distance threshold.

16. The electronic device as claimed in claim 15, wherein the executable instructions comprise instructions to cause the processor to:
move the target material to follow the drag instruction in response to the drag distance exceeding the distance threshold, or
move the target material to follow the drag instruction in response to the drag speed exceeding the speed threshold.

17. A non-transitory computer-readable storage medium having stored therein instructions that, when executed by a processor of an electronic device, causes the electronic device to perform a method for prompting in editing a video, the method comprising:
displaying a preview of a video in a preview region of a video editing page;
obtaining a target material in the preview region;
obtaining first boundary information of the target material in response to the target material being in a selected state;
obtaining second boundary information of a safe region in the preview region; and
displaying prompt information corresponding to the safe region based on the second boundary information, in response to detecting that the target material exceeds the safe region based on the first boundary information and the second boundary information.

18. The non-transitory computer-readable storage medium according to claim 17, said obtaining the second boundary information of the safe region in the preview region comprising:
determining third boundary information of an initial safe region in the video based on an aspect ratio of the video;
obtaining a zoom factor of the preview relative to the video; and
determining the second boundary information based on the third boundary information and the zoom factor.

19. The non-transitory computer-readable storage medium according to claim 18, said determining the third boundary information of the initial safe region in the video based on the aspect ratio of the video comprising:
determining the third boundary information based on the aspect ratio in response to the aspect ratio being not lower than a ratio threshold; and
determining that there is no initial safe region in the video in response to the aspect ratio being lower than the ratio threshold.

20. The non-transitory computer-readable storage medium according to claim 19, said determining the third boundary information based on the aspect ratio comprising:
determining an aspect ratio range of the aspect ratio;
determining a first percentage and a second percentage based on the aspect ratio range, the first percentage being a ratio of a height of the initial safe region to a height of the video, the second percentage being a ratio of a width of the initial safe region to a width of the video; and
determining the third boundary information based on the first percentage and the second percentage.
